(19) United States
(12) Patent Application Publication
(10) Pub. No.: US 2013/0119153 A1
(43) Pub. Date: May 16, 2013

(54) FIELD CROP SPRAY APPARATUS FOR SPRAYING CROPS WITH LIQUIDS

(71) Applicant: Henricus Johannes Godefridus Maria Hoeben, Maarheeze (NL)

(72) Inventor: Henricus Johannes Godefridus Maria Hoeben, Maarheeze (NL)

(21) Appl. No.: 13/735,473

(22) Filed: Jan. 7, 2013

Related U.S. Application Data
(63) Continuation of application No. PCT/NL2011/050491, filed on Jul. 6, 2011.

(30) Foreign Application Priority Data
Jul. 6, 2010 (NL) 2005035

(51) Int. Cl. B05B 15/00

(52) U.S. Cl. CPC B05B 15/001
USPC 239/288.3

(57) ABSTRACT

A field crop spray apparatus comprises a carrier which can be coupled to an agricultural tractor. A plurality of frames are attached to the bottom of the carrier. The free ends of the frames are provided with rotation dampers to which an elongated blade is fitted. This blade runs parallel to the carrier and sprayers are present on top of the blade. The field crop spray apparatus further comprises a cylinder which is connected to the carrier, and also a piston that is movable inside the cylinder and is connected to the blade.

### CROSS-REFERENCE TO RELATED APPLICATIONS

This application for a utility patent is a continuation of a previously filed utility patent, now abandoned, having the application number PCT/NL2011/050491, filed 6 Jul. 2011.

### DESCRIPTION

1. Field Of The Invention

The invention relates to a field crop spray apparatus for spraying crops with liquids, the apparatus comprising an elongated carrier, a plurality of frames connected to the carrier and present at the bottom thereof, an elongated blade connected to the frames and running parallel to the carrier, and sprayers connected to the blade, which field crop spray apparatus is intended to be coupled to an agricultural tractor where the carrier extends at right angles to the direction of movement of the agricultural tractor.

2. State Of The Art

A field crop spray apparatus of this kind is known from EP-A-1 083 789. In this known field crop spray apparatus frames present between the carrier and the blade are made of an elastic material. Owing to undulations of the ground the carrier moves up and down during the use of the field crop spray apparatus. During a down movement of the carrier the blade meets with more resistance from the crop so that the frames spring inwardly.

As a result, the sprayers continue to maintain their distance from the crop, so that the liquid is distributed uniformly over the crop.

### SUMMARY OF THE INVENTION

It is an object of the invention to improve the known field crop spray apparatus. To this end the field crop spray apparatus according to the invention is characterised in that the blade is connected to the frames in a hinging manner and the spray apparatus furthermore comprises at least one cylinder which is connected to the carrier or at least one of the frames, as well as a piston which is movable inside the cylinder and is connected to the blade at a location at a distance from the connection of the blade to the frame. During operation the movement of the blade can be damped by the cylinder. Furthermore, the cylinder can be operated in that the piston can raise the blade. The field crop spray apparatus with a raised blade takes up less space and the distance to the ground is larger, so that the field crop spray apparatus can be transported over the road in a simpler manner.

An embodiment of the field crop spray apparatus according to the invention is characterised in that the piston can be moved with one end in a slot present in the blade. As a result, the cylinder can be rigidly attached to the carrier.

A further embodiment of the field crop spray apparatus according to the invention is characterised in that the piston can be disconnected from the blade. This can lead to an operating condition in which the blade can rotate freely without experiencing a damping effect from the cylinder.

In this operating condition it may be advantageous for the blade to be connected to the frame by means of a radial damper or linear damper so that the hinging movement of the blade is slightly dampened.

A still further embodiment of the field crop spray apparatus according to the invention is characterised in that the frame comprises two parallel arms which are each hingeably connected with one end to the carrier and with the other end are hingeably connected to an intermediate element or the radial damper.

In the field crop spray apparatus according to the invention the sprayer is preferably present on the blade so that there is a substantially constant distance between the sprayer and the crop during operation.

### BRIEF DESCRIPTION OF THE DRAWINGS

The invention will be elucidated more fully below based on examples of embodiment of the spray apparatus according to the invention while reference is made to the appended drawing figures, in which:

FIG. 1 gives a side view of a first embodiment of the spray apparatus according to the invention during the spraying of the crop;

FIG. 2 shows the spray apparatus where the blade is in transport position;

FIG. 3 shows the spray apparatus where the blade is decoupled from the piston; and

FIG. 4 shows a second embodiment of the spray apparatus according to the invention with a double blade.

### DETAILED DESCRIPTION OF THE DRAWINGS

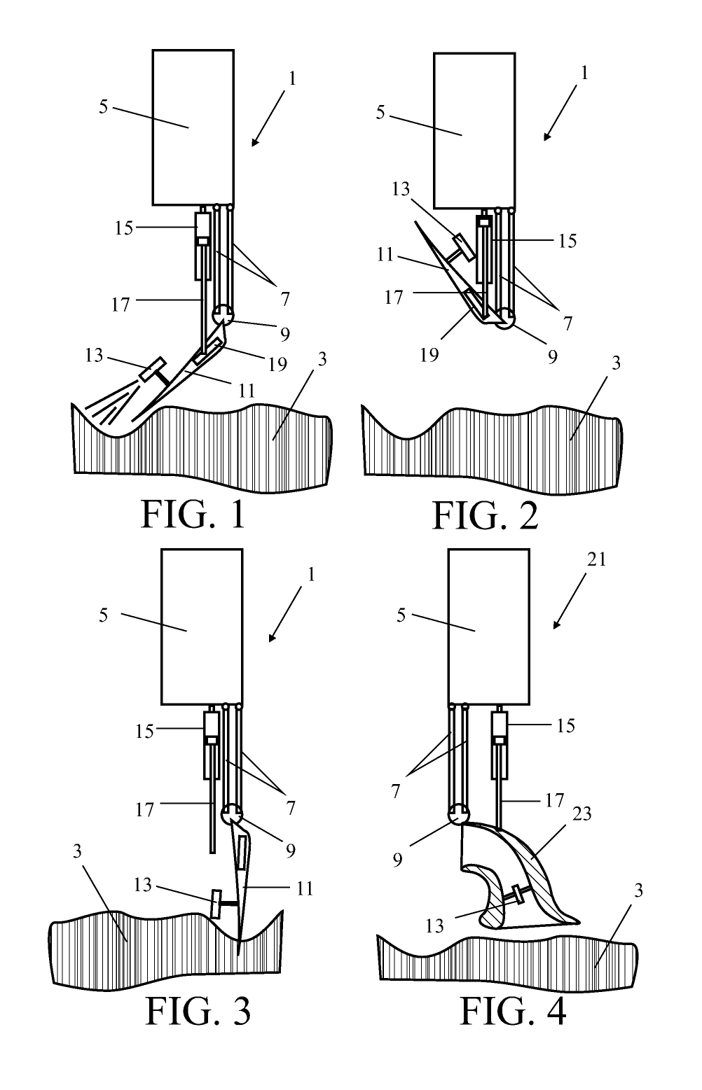

FIGS. 1, 2 and 3 show a first embodiment of the field crop spray apparatus 1 according to the invention for spraying liquid on crops 3 in various operating conditions. The spray apparatus 1 comprises a carrier 5 which can be coupled to an agricultural tractor. A plurality of frames 7 are attached to the bottom of the carrier. The free ends of the frames are provided with intermediate elements or rotation dampers 9. An elongated blade 11 is fitted to these dampers. This blade runs parallel to the carrier 5 and sprayers 13 are present on top of the blade 11.

The field crop spray apparatus is intended to be coupled to an agricultural tractor where the carrier extends at right angles to the direction of movement of the agricultural tractor.

The frame 7 comprises two parallel arms which are each connected with one end in a hinging manner or not to the carrier 5 and with the other end also in a hinging manner or not to the radial damper 9 which damps the hinging movement of the blade 5.

The field crop spray apparatus 1 further comprises a cylinder 15 which is connected to the carrier 5, and also a piston 17 that is movable inside the cylinder 15 and is connected to the blade at a distance from the connection of the blade 11 to the rotation damper 9. The piston 17 can be moved with one end in a slot 19 present in the blade 11 and can also be disconnected from the blade.

FIG. 4 shows a second embodiment of the field crop spray apparatus according to the invention. This spray apparatus 21 is provided with a double blade 23. The two blades are then present at a distance from each other and the sprayer 13 is located in the channel formed between the blades.

Albeit the invention has been described in the foregoing with reference to the drawings, it should be pointed out that the invention is not by any manner or means restricted to the embodiments shown in the drawings. The invention also extends over any embodiment deviating from the embodiments shown in the drawing figures within the spirit and scope defined by the claims.

1. A field crop spray apparatus for spraying crops with liquids, the field crop spray apparatus comprising:
an elongated carrier;
a plurality of frames connected to the carrier and present at the bottom thereof;
an elongated blade connected to the frames and running parallel to the carrier;
sprayers connected to the blade;
wherein the field crop spray apparatus is intended to be coupled to an agricultural tractor such that the carrier extends at right angles to the direction of movement of the agricultural tractor;
wherein the blade is connected to the frames in a hinging manner;
at least one cylinder which is connected to the carrier or at least one of the frames; and
a piston which is movable inside the cylinder and is connected to the blade at a location at a distance from the connection of the blade to the frame.

2. A field crop spray apparatus as claimed in claim 1, wherein the piston can be moved with one end in a slot present in the blade.

3. A field crop spray apparatus as claimed in claim 1, wherein the piston can be disconnected from the blade.

4. A field crop spray apparatus as claimed in claim 1, wherein the blade is connected to the frame by means of a radial damper or a linear damper.

5. A field crop spray apparatus as claimed in claim 1, wherein the frame comprises two parallel arms which are each hingeably connected with one end to the carrier and with the other end are hingeably connected to an intermediate element or the radial damper.

6. A field crop spray apparatus as claimed claim 1, wherein the sprayer is present on the blade.

7. A field crop spray apparatus for spraying crops with liquids from an agricultural tractor, the field crop spray apparatus comprising:
an elongated carrier adapted for mounting the field crop spray apparatus on the agricultural tractor such that the carrier extends at right angles to the direction of movement of the agricultural tractor;
a plurality of frames connected to the carrier and present at the bottom thereof;
an elongated blade connected to the frames with a hinge such that the blade runs parallel to the carrier;
sprayers connected to the blade;
at least one cylinder which is connected to the carrier or at least one of the frames; and
a piston which is movable inside the cylinder and is connected to the blade at a location at a distance from the connection of the blade to the frame.
